(19) United States
(12) Patent Application Publication
(10) Pub. No.: US 2013/0289615 A1
(43) Pub. Date: Oct. 31, 2013

(54) METHOD OF APPLYING A PAD TO A FOOT TO RELIEVE FOOT PAIN

(71) Applicant: 3RD LEG, LLC, Pacific Palisades, CA (US)

(72) Inventor: James Chun Wang, Los Angeles, CA (US)

(73) Assignee: 3rd Leg, LLC, Pacific Palisades, CA (US)

(21) Appl. No.: 13/872,971

(22) Filed: Apr. 29, 2013

Related U.S. Application Data
(60) Provisional application No. 61/640,655, filed on Apr. 30, 2012.

(51) Int. Cl. A61H 39/04

(52) U.S. Cl. CPC A61H 39/04
USPC 606/204

(57) ABSTRACT

The present invention is a method of applying a pad to foot to treat foot pain. The present invention includes the step of securing a pad to a precise pressure point located behind or below a painful or sore portion of a foot. The pressure resulting from the application of the pad to the pressure point of the foot relieves pain from the painful or sore portion of the foot.

### CROSS REFERENCE TO RELATED APPLICATIONS

This Application takes priority from U.S. Provisional Patent Application No. 61/640,655, filed on Apr. 30, 2012, titled “Method of Applying a Pad to a Foot to Relieve Foot Pain”, by inventor James Chun Wang, the contents of which are expressly incorporated herein by this reference as though set forth in their entirety, and to which priority is claimed.

### FIELD OF THE INVENTION

The present invention generally relates to methods of applying a pad to a foot to relieve foot pain, and more particularly, to methods of applying a pad below or behind a sore portion of a foot on a pressure point to relieve foot pain.

### BACKGROUND OF THE INVENTION

For centuries, people have been utilizing pads such as footpads to relieve various types of foot pain and injuries and to prevent chafing when wearing shoes. A conventional footpad is typically secured to the foot of the wearer and is typically attached through an adhesive backing or an adhesive strip. The pad is placed on the foot to protect a sore or painful portion of the foot from direct pressure that may irritate the sore portion. This is generally accomplished by placing the pad, which is typically ring shaped, around the sore portion of the foot and diffusing the pressure applied to the pad, such that acute and irritating pressure is not applied to the sore portion of the foot.

Examples of foot pads that are attached near or around a sore portion of the foot include: U.S. Pat. Nos. 2,148,882 and 2,098,312, both issued to Scholl, and 2,854,974, issued to Ashton. These three references disclose the use of a ring-shaped circular footpad with an adhesive backing that is secured to the bottom of a foot adjacent to a painful portion of the foot in order to relieve the pain. Specifically, the Scholl and Ashton references disclose that the foot pain is relieved by deflecting or diffusing pressure on the painful portion of the foot. However, the Scholl and Ashton references do not disclose that the pain is relieved by putting pressure on a “pressure point” that is behind or below the painful portion of the foot.

Furthermore, the foot conditions that are treated by the Scholl and Ashton footpads are ailments, such as bunions and corn. Conventional methods and the Scholl and Ashton references do not disclose that footpads are used to treat conditions such as arthritis.

Thus, what is needed is a method for placing a pad on a foot such that the pad is placed behind or below a sore portion of the foot. Also, preferably, the pad applies pressure to one or more pressure points on the foot, such that the pressure applied by the footpad on the pressure point relieves a foot pain.

### SUMMARY OF THE INVENTION

To minimize the limitations in the prior art, and to minimize other limitations that will become apparent upon reading and understanding the present specification, the present invention discloses a new and useful method for relieving foot pain by securing a pad to a pressure point that is just below or behind a sore portion of a foot.

One embodiment of the present invention is a method of applying a pad to a foot, the steps comprising: providing a pad; providing a foot; wherein the foot has a painful portion; securing the pad approximately near the painful portion of the foot; wherein the pad is applied and secured to one or more pressure points of the foot; wherein the application of the pad to the one or more pressure points of the foot creates a pressure on the one or more pressure points; and wherein the pressure relieves a pain from the painful portion of the foot. The securing step of the pad may be performed by securing the pad to the one or more pressure points behind the painful portion of the foot. The securing step of the pad may be performed by securing the pad to the one or more pressure points below the painful portion of the foot.

Another embodiment of the present invention is a method of treating foot pain, the steps comprising: providing a pad; providing a foot; wherein the foot has a painful portion; securing the pad approximately near the painful portion of the foot; wherein the pad is applied and secured to a pressure point of the foot; wherein the application of the pad to the pressure point of the foot creates a pressure; and wherein the pressure from the pad to the pressure point relieves pain from the painful portion of the foot. The securing step of the pad may be performed by securing the pad to the one or more pressure points behind the painful portion of the foot. The securing step of the pad may be performed by securing the pad to the pressure point below the painful portion of the foot.

Another embodiment of the present invention is a method of treating foot pain, the steps comprising: providing a pad; providing a foot; wherein the foot has a painful portion; securing the pad approximately near the painful portion of the foot; wherein the pad is applied and secured to a pressure point below the painful portion of the foot; wherein the application of the pad to the pressure point of the foot creates a pressure; and wherein the pressure relieves a pain from the painful portion of the foot.

Another embodiment of the present invention is a method of applying a pad to a foot, the steps comprising: providing a pad; providing a foot with a painful or sore portion; securing the pad behind or below the painful or sore portion of the foot; wherein the pad is secured to a pressure point of the foot; and wherein pressure from the pad to the pressure point relieves pain from the painful or sore portion of the foot.

Another embodiment of the present invention is a method of treating foot pain, the steps comprising: providing a pad; providing a foot with a painful or sore portion; securing the pad behind or below the painful or sore portion of the foot; wherein the pad is secured to a pressure point of the foot; and wherein pressure from the pad to the pressure point relieves pain from the painful or sore portion of the foot.

It is an object of the present invention to overcome the limitations of the prior art.

Other features and advantages are inherent in the method of relieving foot pain claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of the pad.

FIG. 2 is an illustration of a human foot and shows a typical nerve neuroma painful spot and a metatarslia painful spot on a foot.

FIG. 3 is an illustration of a human foot and shows the metatarslia as a painful portion on the foot.

FIG. 4 is an illustration of a human foot and shows the proper placement of one embodiment of the pad on the foot.

FIG. 5 is an illustration of one embodiment of the foot and shows an alternate proper placement of one embodiment of the pad on the foot.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

The present invention is a method for relieving foot pain by securing a pad to a pressure point that is just below or behind a sore portion of a foot. The method for relieving foot pain was based upon a study involving two hundred patients to evaluate the efficacy of the use of the pad in treating common foot pain and injuries. The diagnoses that were treated included, without limitation, neuromas, stress fractures, metatarsalgia and puncture wounds.

The average treatment time occurred for a duration of approximately 7.2 days and the success rate was 98.2%. The subjective pain scale was an average of 8.5 out of 10 before treatment and 2.3 out of 10 after one week of treatment. Upon review, it was discovered that the unsuccessful percentage was due to improper placement or lack of use of the pads.

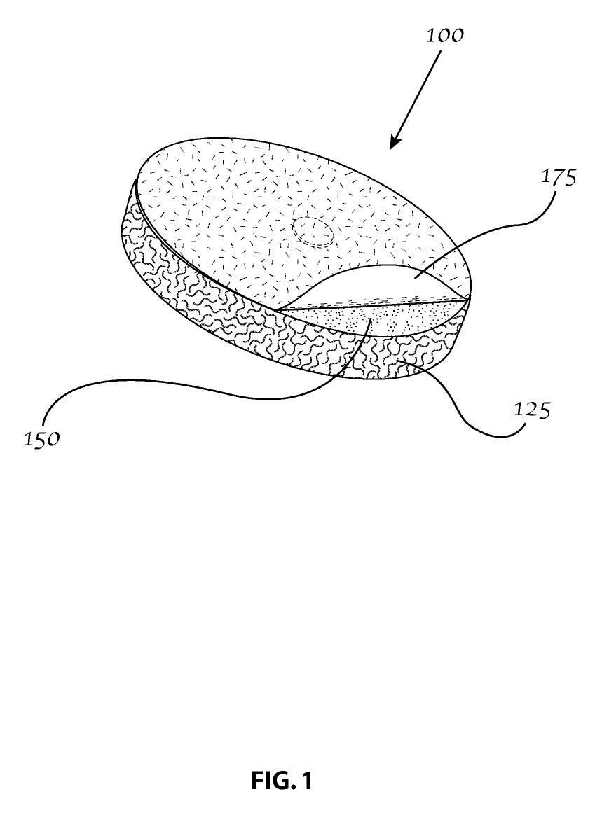

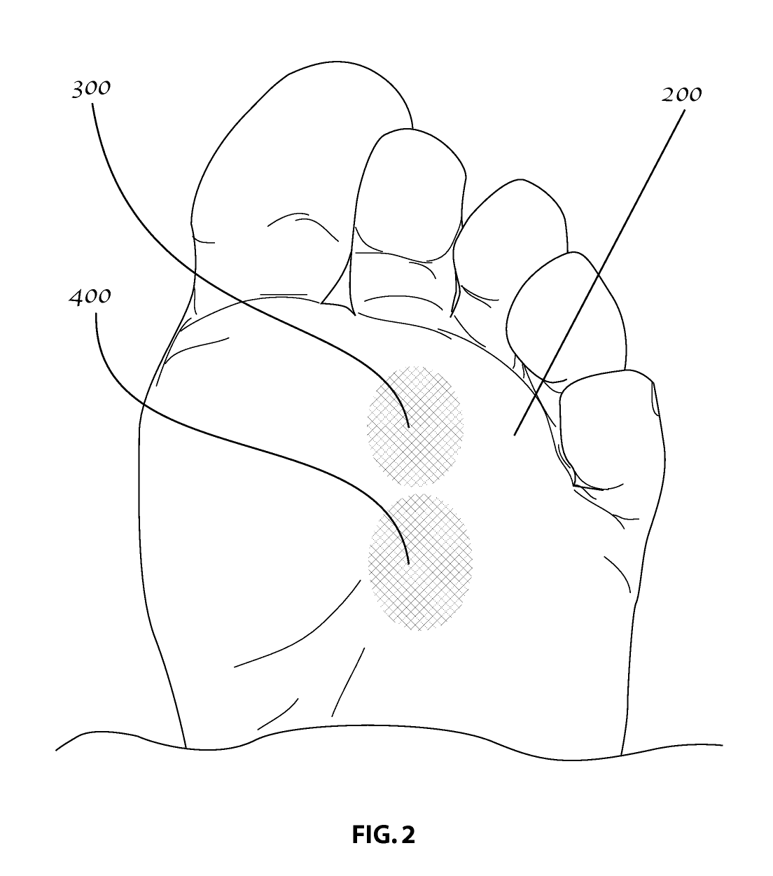

FIG. 1 is an illustration of one embodiment of the pad. As shown in FIG. 1, the pad 100 preferably includes a padding 125; adhesive 150; and backing layer 175. The padding 125 is preferably any soft piece of material use to provide cushion and/or pressure to a wearer upon contact, and is preferably constructed from wool, cotton, felt, foam, cloth, sponge, or any combination thereof. The adhesive 150 is preferably any substance on the padding 125 that, when contacted with the surfaces of a foot 200 (shown in FIG. 2) of the user, removeably binds the pad 100 together with the foot 200. Preferably, the pad 100 has the adhesive 150 on its rear side that becomes exposed upon peeling off a protective backing layer 175. Preferably, the protective backing layer 175 is any thin plastic layer.

In a preferred embodiment, the pad 100 is a quarter-inch thick with a diameter slightly larger than 30.61 millimeters or about the size of a U.S. half-dollar coin. However, it should be understood that smaller and larger pads may be used, depending on the size of the user's foot and the location of the painful portion of the foot. Preferably, the pad 100 is constructed of felt due to the compression characteristics of felt, such as felt is less likely to compress than other materials such as sponges, and preferably, the pad is cut into a disk or circular shape. Although a circular felt pad is preferred, it should be understood that other materials and shapes (e.g., squares, triangles, and rectangles) may be used without deviating from the scope of the invention.

FIG. 2 is an illustration of a human foot and shows a typical nerve neuroma painful spot and a metatarslia painful spot on a foot. The neuroma 300 is generally an enlargement or thickening of a nerve in the foot in the area between the toes, and is usually located at the third interspace between the third and fourth toes, followed by the second interspace between the second and third toes. Generally, the nerve neuroma rarely affects the fourth and first interspaces and is generally found in both feet. On the other hand, the metatarslia 400 generally refers to any painful foot condition affecting the metatarsal region of the foot. The metatarslia 400 is a typical problem that can affect the joints and bones of the metatarsals and is most often localized to the first metatarsal head (the ball of the foot just behind the big toe). Both neuromas and metatarslia are representative of the painful portions to which the pad is used for.

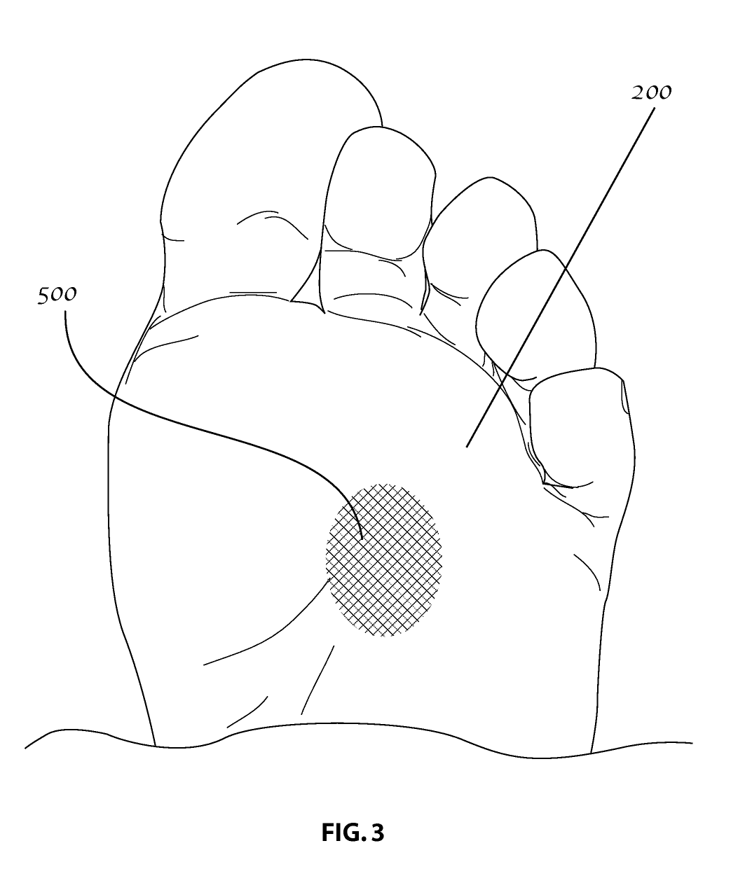

FIG. 3 is an illustration of a human foot and shows the metatarslia as a painful portion on the foot. Specifically, the painful portion 500 of the foot may be the metatarslia 400, to which the pad 100 may be used for. However, the painful portion 500 may include the nerve neuroma painful spot 300 and other sore spots without deviating from the scope of the invention.

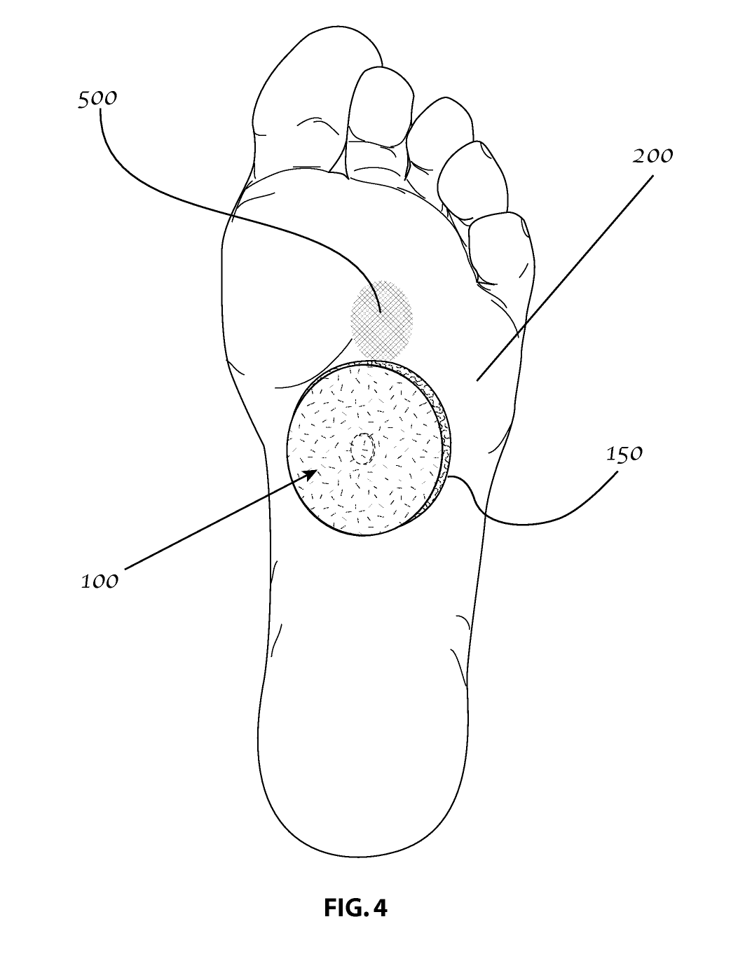

FIG. 4 is an illustration of a human foot and shows the proper placement of one embodiment of the pad on the foot. As shown in FIG. 4, the method of applying a pad to a foot to relieve foot pain preferably includes a foot 200 and a pad 100. Preferably, the pad 100 should be positioned just below the painful portion 500 on the foot and towards the heel of the foot. The pad 100 is generally secured to a pressure point below the painful portion 500 of the foot via adhesive 150, such that, upon standing up, the pressure of the pad 100 preferably delivers to the pressure point a relief of pain from the painful portion 500 on the foot 200.

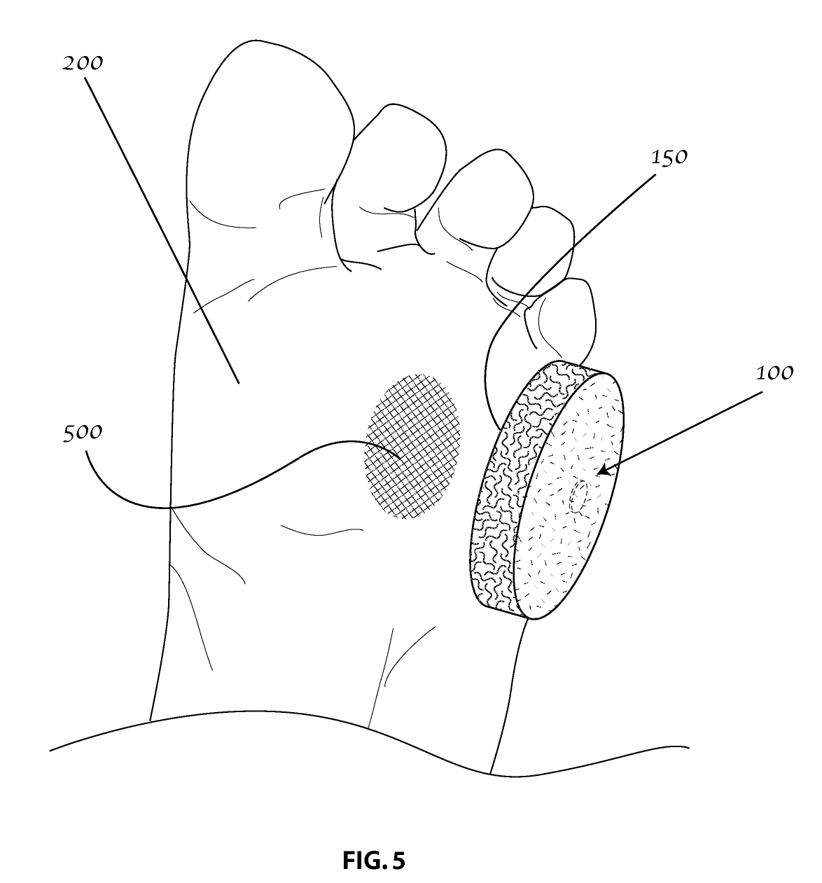

FIG. 5 is an illustration of one embodiment of the foot and shows an alternate proper placement of one embodiment of the pad on the foot. As shown in FIG. 5, the method of applying a pad to a foot to relieve foot pain preferably includes a foot 200 and a pad 100. In an alternate embodiment, the pad 100 may be positioned on the right-side or adjacent to the painful portion 500 on the foot and preferably in contact with a pressure point adjacent to the painful portion 500 of the foot. When the user stands up, the pressure resulting from the pad 100 preferably delivers to another pressure point relief of pain from the painful portion 500 on the foot 200.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method of applying a pad to a foot, the steps comprising:
providing a pad;
providing a foot;
wherein said foot has a painful portion;
securing said pad approximately near said painful portion of said foot;
wherein said pad is applied and secured to one or more pressure points of said foot;
wherein said application of said pad to said one or more pressure points of said foot creates a pressure on said one or more pressure points; and
wherein said pressure relieves a pain from said painful portion of said foot.

2. The method of applying a pad to a foot of claim 1, wherein said securing step of said pad is performed by securing said pad behind said painful portion of said foot.

3. The method of applying a pad to a foot of claim 1, wherein said securing step of said pad is performed by securing said pad to said one or more pressure points below said painful portion of said foot.

4. A method of treating foot pain, the steps comprising:
providing a pad;
providing a foot;
wherein said foot has a painful portion;
securing said pad approximately near said painful portion of said foot;
wherein said pad is applied and secured to a pressure point of said foot;
wherein said application of said pad to said pressure point of said foot creates a pressure; and
wherein said pressure from said pad to said pressure point relieves pain from said painful portion of said foot.

5. The method of applying a pad to a foot of claim 4, wherein said securing step of said pad is performed by securing said pad behind said painful portion of said foot.

6. The method of applying a pad to a foot of claim 4, wherein said securing step of said pad is performed by securing said pad to said pressure point below said painful portion of said foot.

7. A method of treating foot pain, the steps comprising:
providing a pad;
providing a foot;
wherein said foot has a painful portion;
securing said pad approximately near said painful portion of said foot;
wherein said pad is applied and secured to a pressure point below said painful portion of said foot;
wherein said application of said pad to said pressure point of said foot creates a pressure; and
wherein said pressure relieves a pain from said painful portion of said foot.
